(19) United States
(12) Patent Application Publication
(10) Pub. No.: US 2019/0054498 A1
(43) Pub. Date: Feb. 21, 2019

(54) LAMINATED COATING FILM, AND COATED ARTICLE

(71) Applicant: MAZDA MOTOR CORPORATION, Hiroshima (JP)

(72) Inventors: Takakazu YAMANE, Hiroshima-shi, Hiroshima (JP); Kouji TERAMOTO, Hiroshima-shi, Hiroshima (JP); Fumi HIRANO, Hiroshima-shi, Hiroshima (JP); Keiichi OKAMOTO, Hiroshima-shi, Hiroshima (JP)

(73) Assignee: MAZDA MOTOR CORPORATION, Hiroshima (JP)

(21) Appl. No.: 16/079,235

(22) PCT Filed: Feb. 23, 2017
(86) PCT No.: PCT/JP2017/006838

§ 371 Date: Aug. 23, 2018

(30) Foreign Application Priority Data
Feb. 26, 2016 (JP) 2016-035813

(51) Int. Cl. B05D 5/06; C09C 1/62; B05D 1/36

(52) U.S. Cl. CPC B05D 5/068; B05D 5/066; B05D 1/36; C09C 1/62

(57) ABSTRACT

The multilayer coating film 12 includes a lower coating film 14 and an upper coating film 15. The lightness L* value of the coating film 14 is 30 or less. The coating film 15 contains aluminum flakes 22. The aluminum flakes 22 each have a surface roughness Ra of 30 nm or less and having a thickness of 70 to 150 nm. With respect to the aluminum flakes contained in the coating film 14, 70% by mass or more thereof has a major axis length of 7 to 15 μm and an aspect ratio of 3 or less. When all the aluminum flakes 22 contained in the coating film 15 are projected on a surface of the coating film 15, a projected area occupancy, which is an area occupancy of the projections of the aluminum flakes 22 on the surface of the coating film 15, is 40 to 90%.

### TECHNICAL FIELD

The present invention relates to a multilayer coating film and a coated object.

### BACKGROUND ART

Generally, it has been attempted to apply a plurality of coating films on top of each other on a base surface of a body of an automobile, a component of an automobile, or the like in order to improve protection and appearance of the base. For example, Patent Document 1 discloses applying a deep color coat to a coating target, wherein the deep color coat is N0 to N5 on the Munsell color chart and contains a deep color pigment (carbon black) and wherein the coating target is a metal plate coated with a cationic electrodeposition coat and an intermediate coat. After that, a metallic coat containing scale-like aluminum pigments, each having a thickness of 0.1 μm to 1 μm and having an average particle size of 20 μm, is applied to a surface of the deep color coat. A clear coat is further applied thereto to obtain a multilayer coating film with significant flip-flop properties.

Patent Document 2 discloses a composition of a metallic coat containing three kinds of aluminum flake pigments A to C. The aluminum flake pigment A has an average particle size D50 of 13 μm to 40 μm and an average thickness of 0.5 μm to 2.5 μm. The aluminum flake pigment B has an average particle size D50 of 13 μm to 40 μm and an average thickness of 0.01 μm to 0.5 μm. The aluminum flake pigment C has an average particle size D50 of 4 μm to 13 μm, and the average thickness of 0.01 μm to 1.3 μm. The mass ratios of the solid content of the aluminum flake pigments A to C are set to be as follows: A/B is 10/90 to 90/10; and (A+B)/C is 90/10 to 30/70. The solid content of (A+B+C) with respect to 100 parts by mass of the solid content of resin is set to be 5 parts by mass to 50 parts by mass. Such constituents are intended to improve the luminance, the flip-flop properties, and the hiding properties.

Patent Document 3 discloses obtaining a luster coating film by applying, to a resin base, a coat which contains flat luster materials made of aluminum. The luster materials are oriented such that their flat surfaces lie along a coating film surface, and are arranged such that the average overlapping number y (which is an average number of the luster materials that intersect with one of orthogonal lines orthogonal to the coating film surface) and the average distance x (which is an average distance between adjacent luster materials in the direction of a same orthogonal line with which the adjacent luster materials intersect) satisfy a given relationship. Luster and electromagnetic wave permeability can be achieved in this manner.

### CITATION LIST

### Patent Document

Patent Document 1: Japanese Unexamined Patent Publication No. H10-192776

Patent Document 2: Japanese Unexamined Patent Publication No. 2005-200519

Patent Document 3: Japanese Unexamined Patent Publication No. 2010-30075

### SUMMARY OF THE INVENTION

### Technical Problem

Basically, in a structure such as the structure disclosed in Patent Document 1 in which a metallic coating film containing aluminum flakes is layered on a deep color coating film of low lightness, a luster impression increases at highlights due to the metallic coating film and decreases at shades due to the deep color coating film visible through the metallic coating film. However, such a structure does not always achieve metallic luster.

A reduction in diffuse reflection of light is considered to be necessary so that a metallic texture of a coating film can be achieved by the aluminum flakes added thereto. For this reason, the aluminum flakes in the coating film are oriented parallel to the coating film surface. However, even in that case, diffuse reflection occurs at an edge of the periphery of each aluminum flake, and diffuse reflection also occurs due to a level difference between the aluminum flakes. The diffuse reflection gives the multilayer coating film a whitish appearance.

As a measure against the diffuse reflection, a vapor-deposited aluminum pigment obtained by pulverizing an aluminum film removed from a vapor-deposited aluminum film may be used as a luster material. The vapor-deposited aluminum pigment has a very smooth surface, which causes a strong geometric optical reflection on its surface. In addition, the vapor-deposited aluminum pigment is very thin, which reduces a level difference between the particles and hence reduces the diffuse reflection due to the level difference. However, the strong geometric optical reflection may create a mirror-like state, in which the highlights are too strong and reflections are also strong. As a result, the metallic impressions may not be obtained in some cases.

The present invention is therefore intended to achieve, by applying a coat, a texture of a nicely polished metal, the diffuse reflection of which is not as strong as a known metallic coat, and the reflection of which is not a mirror-like geometric optical reflection. Such metallic texture may be achieved by controlling distribution of orientation angles of luster materials with respect to a surface of a luster material-containing layer. However, in practice, the orientation angles of the luster materials can hardly be controlled through properties of paint or a coating technique. The present invention achieves the above objective from a different viewpoint than the control of the orientation angles.

### Solution to the Problem

The present inventors conducted various experiments and studies and achieved the “metallic texture” through appropriate control over the geometric optical reflection and the diffuse reflection.

A multilayer coating film disclosed herein includes a lower coating film formed directly or indirectly on a surface of a coating target, and an upper coating film layered on the lower coating film, wherein

a lightness L* value of the lower coating film is 30 or less,
the upper coating film contains a large number of aluminum flakes as a luster material,
the aluminum flakes each have a surface roughness Ra of 30 nm or less,
the aluminum flakes each have a thickness of 70 nm or more and 150 nm or less,
the aluminum flakes contained in the upper coating film have an aspect ratio of 3 or less obtained by dividing a major axis length of the aluminum flake by a minor axis length thereof, and if a particle size of the aluminum flake is set to be a square root of a product of the major axis length and the minor axis length, an average particle size is 7 μm or more and 15 μm or less, and a standard deviation of a particle size distribution is 30% or less of the average particle size, and
when all the aluminum flakes contained in the upper coating film are projected on a surface of the upper coating film, a projected area occupancy, which is an area occupancy of projections of the aluminum flakes on the surface of the upper coating film, is 40% or more and 90% or less.

According to the above multilayer coating film, a lightness L* value of the lower coating film is 30 or less. Thus, the lightness of the multilayer coating film greatly decreases due to the lower coating film visible through the upper coating film when the viewing angle with respect to the multilayer coating film is changed from highlights to shades. That is, the lightness (i.e., highlights) and the darkness (i.e., shades) become more distinct (that is, remarkable flip-flop properties can be obtained).

In general, projections and depressions, if any, on a surface of the aluminum flake may produce an optical path difference between the optical path of light reflected by the depression and the optical path of light reflected by the projection. However, the surface roughness Ra of the aluminum flake contained in the upper coating film is 30 nm or less, which means that the interference due to the optical path difference is small in the case of visible light wavelengths (i.e., 400 nm to 800 nm) (this point will be described in detail later). Thus, there is almost no diffuse reflection component on the surface of the aluminum flake, which means that strong geometric optical reflection is obtainable.

On the other hand, as described earlier, the light reflection by the aluminum flakes includes the diffuse reflection due to a level difference between the aluminum flakes and the diffuse reflection due to the edge of the periphery of each aluminum flake.

In the case of the multilayer coating film described above, the thickness of the aluminum flake is 70 nm or more and 150 nm or less. Thus, a certain degree of diffuse reflection occurs in the upper coating film due to the level difference between the aluminum flakes. However, the aluminum flakes contained in the upper coating film have an aspect ratio of 3 or less obtained by dividing a major axis length of the aluminum flake by a minor axis length thereof, and if a particle size of the aluminum flake is defined as a square root of a product of the major axis length and the minor axis length, an average particle size is 7 μm or more and 15 μm or less, and a standard deviation of a particle size distribution is 30% or less of the average particle size. This means that the diffuse reflection due to the edges of the aluminum flakes is not so strong.

The longer the edge is, the stronger the diffuse reflection due to the edge becomes. Thus, the aluminum flakes having the average particle size of 7 μm or more and the aspect ratio of 3 or less are those aluminum flakes in which the length of the edge (i.e., the perimeter) of one aluminum flake with respect to the reflective surface of the aluminum flake is not long. That is, the diffuse reflection due to the edge of an individual aluminum flake is weak, while the individual aluminum flake may produce a strong geometric optical reflection due to the surface roughness Ra described above. The preferable aspect ratio is 2 or less.

In addition, the average particle size of the aluminum flakes contained in the upper coating film is 15 μm or less. The individual aluminum flakes are therefore not noticeable by an external visual check, and so-called particle texture is not perceived.

The projected area occupancy of the aluminum flakes in the upper coating film will now be described. The greater the projected area occupancy is, the stronger the geometric optical reflection of light due to the aluminum flakes becomes. The great projected area occupancy means that there are many aluminum flakes overlapping one another. That is, the greater projected area occupancy leads to stronger diffuse reflection due to the level difference of the aluminum flakes. Therefore, the projected area occupancy is preferably 40% or more in terms of ensuring the geometric optical reflection, and preferably 90% or less in terms of reducing the diffuse reflection due to the level difference of the aluminum flakes.

In short, the multilayer coating film of the present invention has a proper diffuse reflection ratio with respect to a geometric optical reflection, and therefore may present a texture of a nicely polished metal due to a combination of the settings of the surface roughness Ra, thickness, aspect ratio, and particle size of the aluminum flakes and the settings of the projected area occupancy of the aluminum flakes.

In a preferred embodiment, the projected area occupancy is 50% or more and 80% or less.

Preferably, the upper coating film has a thickness of 1.5 μm or more and 4 μm or less. The aluminum flakes are not well oriented in the upper coating film if the upper coating film has a thickness of greater than 4 μm, which results in a weak geometric optical reflection. However, it is difficult to form a coating film having a thickness of less than 1.5 μm, and the interference of the aluminum flakes may easily occur in such a coating film.

The coated object including the multilayer coating film provided on a coating target is, for example, an automobile body. The coated object may also be a body of a motorcycle or bodies of other vehicles, or may be other metal products.

### Advantages of the Invention

According to the present invention: a lightness L* value of a lower coating film is set to be 30 or less; aluminum flakes contained in an upper coating film have a surface roughness Ra of 30 nm or less, a thickness of 70 nm or more and 150 nm or less, an aspect ratio of 3 or less obtained by dividing a major axis length of the aluminum flake by a minor axis length thereof; if a particle size of the aluminum flake is defined as a square root of a product of the major axis length and the minor axis length, an average particle size is 7 μm or more and 15 μm or less, and a standard deviation of a particle size distribution is 30% or less of the average particle size; and a projected area occupancy of the aluminum flakes in the upper coating film is set to be 40% or more and 90% or less. The multilayer coating film of the present invention therefore has a proper diffuse reflection ratio with respect to a geometric optical reflection, and hence may present a texture of a nicely polished metal and remarkable flip-flop properties.

### BRIEF DESCRIPTION OF THE DRAWINGS

FIG. 1 is a diagram schematically illustrating a cross-sectional view of a multilayer coating film.

FIG. 2 is a diagram for explaining a geometric optical reflection on an aluminum flake surface.

FIG. 3 is a diagram for explaining a diffuse reflection due to an edge of an aluminum flake.

FIG. 4 is a diagram for explaining a diffuse reflection due to a level difference between aluminum flakes.

FIG. 5 is a picture of an upper coating film taken from a surface side thereof.

FIG. 6 is a diagram for showing a preferable range of the major axis length of an aluminum flake and a preferable range of a projected area occupancy (i.e., a rate of overlapping) of aluminum flakes.

### DESCRIPTION OF EMBODIMENT

An embodiment of the present invention will now be described with reference to the drawings. The following description of a preferred embodiment is only an example in nature, and is not intended to limit the scope, applications or use of the present invention.

<Example Configuration of Multilayer Coating Film>

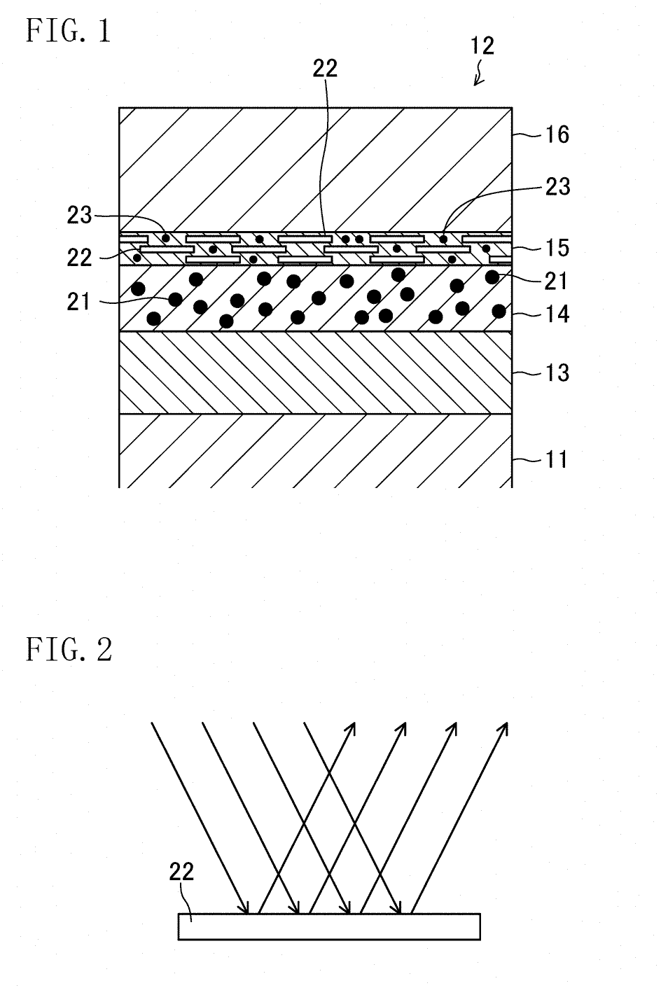

As illustrated in FIG. 1, a multilayer coating film 12 provided on a surface of an automotive body (steel plate) 11 according to the present embodiment contains a lower coating film 14, an upper coating film 15, and a transparent clear coating film 16 which are sequentially stacked one upon the other. An electrodeposition coating film (undercoat) 13 is formed on the surface of the automotive body 11 by cationic electrodeposition. The multilayer coating film 12 is provided on the electrodeposition coating film 13. A surfacer film may be provided between the multilayer coating film 12 and the electrodeposition coating film 13. According to the present invention, the electrodeposition coating film 13, the surfacer film, and the transparent clear coating film 16 may or may not be provided.

The lower coating film 14 is a solid layer, which contains a deep color pigment 21 as a coloring agent and does not contain any luster material. The upper coating film 15 is a metallic layer, which contains aluminum flakes 22 as a luster material. FIG. 1 illustrates an example in which the upper coating film 15 contains a pigment 23 as a coloring agent. However, the upper coating film 15 does not necessarily have to contain the coloring agent. Pigments of various hues including, for example, a black pigment (e.g., carbon black, perylene black, and aniline black) or a red pigment (e.g., perylene red) may be employed as the pigments 21 and 23. In a case where the pigment 23 is added to the upper coating film 15, it is preferable to employ, as the pigment 23, a pigment having a similar color to that of the pigment 21 of the lower coating film 14, for example. However, the pigments do not necessarily have to be in similar colors.

<Details of Lower and Upper Coating Films>

The lightness L* value of the lower coating film 14 is 30 or less, and more preferably set to be 20 or less. The “lightness L* value” used herein is a value of the lightness L* of the L*a*b* color system, in which a greater L* value represents a color closer to white (L*=100) and a smaller L* value represents a color closer to black (L*=0).

The thickness of the upper coating film 15 is 1.5 μm or more and 4 μm or less. The aluminum flakes 22 in the upper coating film 15 each have a surface roughness Ra of 10 nm or more and 30 nm or less and a thickness of 70 nm or more and 150 nm or less.

The surface roughness Ra of the aluminum flake 22 is set to be 30 nm or less in order to reduce the interference of visible light waves (wavelengths of 400 nm to 800 nm) due to an optical path difference. To be more specific, suppose that the level difference between a projection and a depression on the surface of the aluminum flake 22 is referred to as “d” and a refractive index of resin in the upper coating film 15 is referred to as “n.” Then, the optical path difference caused by the difference d is expressed as 2×n×d. If the optical path difference 2×n×d is one fourth (i.e., ¼) or less of the wavelength λ of light (that is, if the phase difference is π/2 or less), there is only slight interference of light. In a case where the wavelength is 700 nm and the refractive index n is 1.5, the difference d is expressed by d=(½n)×(¼)×λ≈58 nm. If this is expressed in terms of the surface roughness Ra, Ra is equal to 29 nm (Ra=29 nm). In a case of Ra≤30, strong interference which may cause a diffuse reflection does not occur.

That is, as illustrated in FIG. 2, the reflection of incident light on the surface of the aluminum flake 22 is substantially a geometric optical reflection.

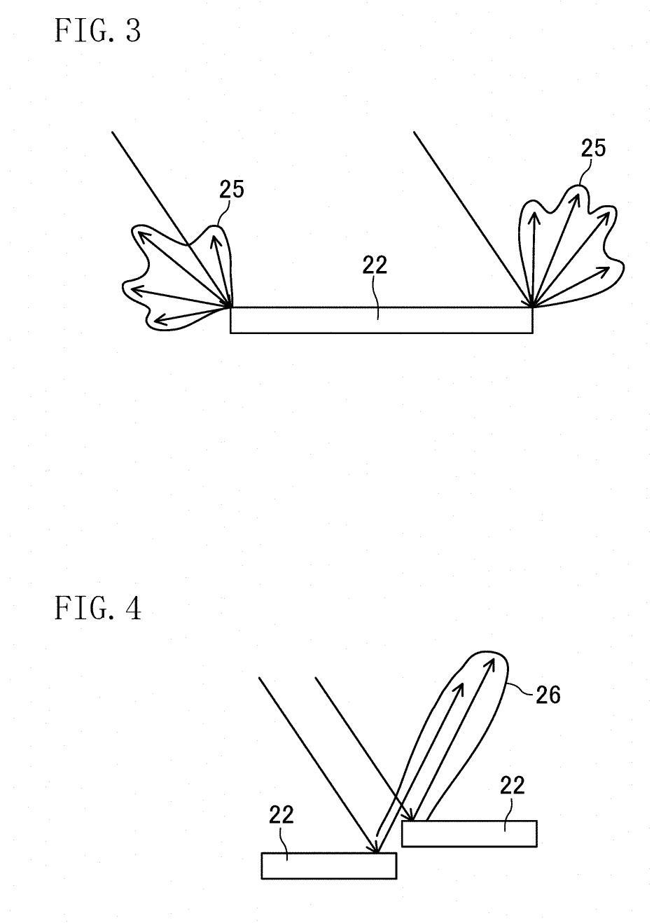

The aluminum flake 22 contained in the upper coating film 15 has an aspect ratio of 3 or less obtained by dividing the major axis length of the aluminum flake 22 by the minor axis length thereof. If the particle size of the aluminum flake is defined as the square root of the product of the major axis length and the minor axis length, the average particle size is 7 μm or more and 15 μm or less, and the standard deviation of the particle size distribution is 30% or less of the average particle size. The preferable aspect ratio is 2 or less. The aluminum flake 22 configured as described above may appropriately reduce the diffuse reflection 25 at the edge of the aluminum flake 22 illustrated in FIG. 3.

When all the aluminum flakes 22 contained in the upper coating film 15 are projected on a surface of the upper coating film 15, a projected area occupancy, which is an area occupancy of the projections of the aluminum flakes 22 on the surface of the upper coating film 15, is 40% or more and 90% or less. More preferably, the projected area occupancy is 50% or more and 80% or less. The projected area occupancy corresponds to a rate of overlapping of the aluminum flakes 22 in the thickness direction of the upper coating film 15, and serves as an index indicating a degree of the diffuse reflection 26 caused by the level difference between the aluminum flakes 22 illustrated in FIG. 4. Setting the projected area occupancy within the range described above may properly reduce the diffuse reflection caused by the level difference of the aluminum flakes.

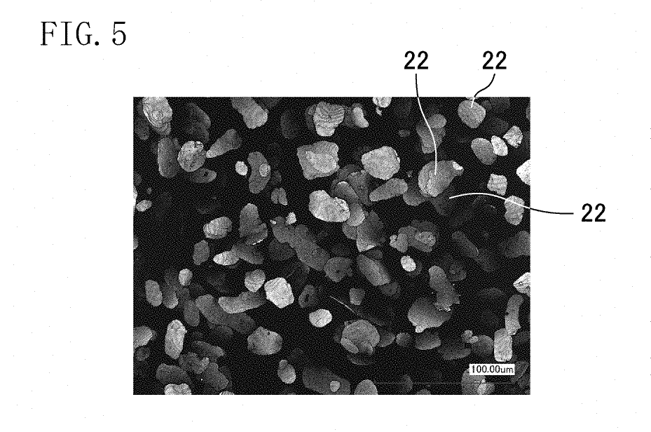

When a plan view of the upper coating film applied onto a steel base is observed, the aluminum flakes 22 contained in the upper coating film are visible as shown in FIG. 5. Note that no pigment is contained in the sample upper coating film shown in FIG. 5. Since the aluminum flake 22 is thin (having a thickness of 70 nm or more and 150 nm or less), not only the aluminum flakes 22 present near the surface of the upper coating film, but also the aluminum flakes 22 present at deeper levels are visible through the aluminum flakes 22 near the surface of the upper coating film. Since the upper coating film is thin (having a thickness of 1.5 μm or more ad 4 μm or less), all the aluminum flakes 22 including the aluminum flakes 22 present at a bottom portion of the upper coating film are visible even in a case where a pigment is contained therein. The projected area occupancy is obtainable from an image of the upper coating film taken from its surface side with or without the transparent clear layer provided on the surface.

The rate of overlapping can be expressed by the following equation, where “Σ reflection area” refers to the total sum of reflective surfaces, which reflect incident light, of all the aluminum flakes 22 contained in the upper coating film 15.

Rate of overlapping (%)=[(Σ reflection area−projected area)/Σ reflection area]×100

A larger projected area occupancy means that there are a lot of aluminum flakes 22 contained in the upper coating film 15, which accordingly increases the rate of overlapping and thus enhances the diffuse reflection caused by the level difference. The rate of overlapping is preferably 21% or more and 59% or less, and more preferably 27% or more and 49% or less.

An amount of the aluminum flakes 22 contained in the upper coating film 15 is preferably 6% or more and 25% or less in PWC (that is, aluminum flake weight/(aluminum flake weight+resin composition weight)×100).

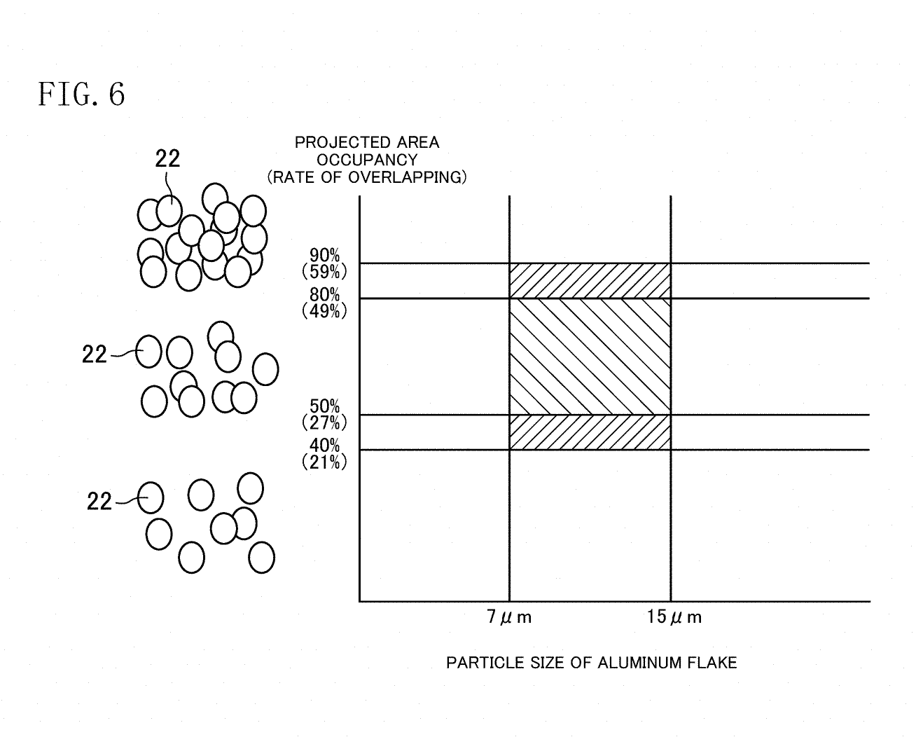

FIG. 6 is a diagram for showing a preferable range of the major axis length of the aluminum flake 22 and a preferable range of the projected area occupancy (i.e., the rate of overlapping). The percentages in parentheses on the vertical axis represent rates of overlapping.

The resin component of each of the lower coating film 14 and the upper coating film 15 is not particularly limited. For example, acrylic resin, polyester resin, polyurethane resin, vinyl resin, or the like can be used as the resin component.

The resin component of the transparent clear layer 16 is not particularly limited. A combination of acrylic resin and/or polyester resin and amino resin, or acrylic resin and/or polyester resin cured by reaction of a carboxylic acid and epoxy curing system can be used.

### EXAMPLES AND COMPARATIVE EXAMPLES

### Example 1

A multilayer coating film comprised of a lower coating film (a solid layer) and an upper coating film (a metallic layer) was provided on a surface of a steel base. Acrylic melamine resin was used as the resin of the lower coating film. Carbon black was used as a pigment of the lower coating film. The thickness of the lower coating film and the pigment concentration were adjusted so that the lightness L* value be expressed by L* value=3. Specifically, the amount of the carbon black contained therein was set to be 8.5% in PWC and the film thickness was 20 μm.

The upper coating film was formed to have a thickness of 2.5 μm and contain the aluminum flakes at 11% in PWC. No coloring agent (i.e., a pigment) was contained in the upper coating film.

The aluminum flakes contained in the upper coating film had the following features: the surface roughness Ra was 15 nm; the average value of the aspect ratios was 1.5; the average particle size was 11 μm; the standard deviation of the particle size distribution was 10% to 20% of the average particle size; the thickness was 0.11 μm, and the projected area occupancy of the aluminum flakes was 61% (that is, the rate of overlapping was 35%).

### Examples 2 to 15 and Comparative Examples 1 to 6

As shown in Tables 1 and 2, multilayer coating films of Examples 2 to 4 and Comparative Examples 1 to 6 were formed, of which the lightness L* value of the lower coating film, or the thickness of the upper coating film, or the aluminum flake content, or the surface roughness Ra, average particle size, thickness, or projected area occupancy (i.e., the rate of overlapping) of the aluminum flake was distinct from one another. The average value of the aspect ratios of the aluminum flakes was 1.5 in all of the multilayer coating films. The standard deviation of the particle size distribution of the aluminum flakes was 10% to 20% of the average particle size in all of the multilayer coating films.

TABLE 1

| | | | Example 1 | Example 2 | Example 3 | Example 4 | Example 5 | Example 6 |
|---|---|---|---|---|---|---|---|---|
| Upper Coating Film | Aluminum | Surface Roughness Ra (nm) | 15 | 15 | 15 | 30 | 15 | 15 |
| | Features | Average Particle Size (μm) | 11 | 11 | 11 | 11 | 11 | 11 |
| | | Thickness (μm) | 0.11 | 0.11 | 0.11 | 0.11 | 0.07 | 0.15 |

| | | | | | | | |
|---|---|---|---|---|---|---|---|
| | Aluminum Content (%) in PWC | 11 | 11 | 11 | 11 | 11 | 11 |
| | Coating Film Thickness (μm) | 2.5 | 2.5 | 2.5 | 2.5 | 2.5 | 2.5 |
| | Area Occupancy (%) | 61 | 61 | 61 | 61 | 78 | 51 |
| | Rate of Overlapping (%) | 35 | 35 | 35 | 35 | 47 | 27 |
| Lower | Carbon Content (%) in PWC | 8.5 | 2.6 | 1.3 | 8.5 | 8.5 | 8.5 |
| Coating | Coating Film Thickness (μm) | 20 | 20 | 20 | 20 | 20 | 20 |
| | L* Value | 3 | 20 | 30 | 3 | 3 | 3 |

| | | | | | | |
|---|---|---|---|---|---|---|
| Metallic Texture Evaluation | ⊚ | ⊚ | ◯ | ◯ | ◯ | ◯ |

| | | | Example 7 | Example 8 | Example 9 | Example 10 | Example 11 |
|---|---|---|---|---|---|---|---|
| Upper Coating Film | Aluminum | Surface Roughness Ra (nm) | 15 | 15 | 15 | 15 | 15 |
| | Features | Average Particle Size (μm) | 7 | 15 | 11 | 11 | 11 |
| | | Thickness (μm) | 0.11 | 0.11 | 0.11 | 0.11 | 0.11 |

| | | | | | | |
|---|---|---|---|---|---|---|
| | Aluminum Content (%) in PWC | 11 | 11 | 11 | 11 | 6 |
| | Coating Film Thickness (μm) | 2.5 | 2.5 | 1.5 | 4 | 2.5 |
| | Area Occupancy (%) | 61 | 61 | 41 | 79 | 41 |
| | Rate of Overlapping (%) | 35 | 35 | 23 | 48 | 22 |
| Lower | Carbon Content (%) in PWC | 8.5 | 8.5 | 8.5 | 8.5 | 8.5 |
| Coating | Coating Film Thickness (μm) | 20 | 20 | 20 | 20 | 20 |
| | L* Value | 3 | 3 | 3 | 3 | 3 |

| | | | | | |
|---|---|---|---|---|---|
| Metallic Texture Evaluation | ◯ | ◯ | ◯ | ◯ | ◯ |

Note:
The term “aluminum” refers to “aluminum flakes.”
The term “area occupancy” refers to “projected area occupancy of aluminum flakes.”
The term “carbon” refers to “carbon black.”

TABLE 2

| | | | | | | | Comparative |
|---|---|---|---|---|---|---|---|
| | | | Example 12 | Example 13 | Example 14 | Example 15 | Example 1 |
| Upper Coating Film | Aluminum | Surface Roughness Ra (nm) | 15 | 25 | 20 | 20 | 20 |
| | Features | Average Particle Size (μm) | 11 | 9 | 14 | 14 | 14 |
| | | Thickness (μm) | 0.11 | 0.15 | 0.14 | 0.14 | 0.14 |
| | Aluminum Content (%) in PWC | | 25 | 13 | 9 | 21 | 29 |
| | Coating Film Thickness (μm) | | 2.5 | 4 | 3 | 3 | 3 |
| | Area Occupancy (%) | | 90 | 76 | 52 | 86 | 95 |
| | Rate of Overlapping (%) | | 59 | 45 | 28 | 54 | 66 |
| Lower | Carbon Content (%) in PWC | | 8.5 | 8.5 | 8.5 | 8.5 | 8.5 |
| Coating | Coating Film Thickness (μm) | | 20 | 20 | 20 | 20 | 20 |
| | L* Value | | 3 | 3 | 3 | 3 | 3 |
| Metallic Texture Evaluation | | | ◯ | ◯ | ⊚ | ◯ | X |
| | | | Comparative | Comparative | Comparative | Comparative | Comparative |
| | | | Example 2 | Example 3 | Example 4 | Example 5 | Example 6 |
| Upper Coating Film | Aluminum | Surface Roughness Ra (nm) | 45 | 30 | 20 | 15 | 15 |
| | Features | Average Particle Size (μm) | 12 | 5 | 18 | 11 | 11 |
| | | Thickness (μm) | 0.12 | 0.15 | 0.15 | 0.11 | 0.11 |

| | | | | | | |
|---|---|---|---|---|---|---|
| | Aluminum Content (%) in PWC | 14 | 15 | 15 | 5 | 11 |
| | Coating Film Thickness (μm) | 2.5 | 3 | 3 | 2.5 | 2.5 |
| | Area Occupancy (%) | 70 | 70 | 70 | 36 | 61 |
| | Rate of Overlapping (%) | 41 | 40 | 40 | 18 | 35 |
| Lower | Carbon Content (%) in PWC | 8.5 | 8.5 | 8.5 | 8.5 | 0.5 |
| Coating | Coating Film Thickness (μm) | 20 | 20 | 20 | 20 | 20 |
| | L* Value | 3 | 3 | 3 | 3 | 45 |

| | | | | | |
|---|---|---|---|---|---|
| Metallic Texture Evaluation | X | X | X | X | X |

Note:
The term “aluminum” refers to “aluminum flakes.”
The term “area occupancy” refers to “projected area occupancy of aluminum flakes.”
The term “carbon” refers to “carbon black.”

[Evaluation of Metallic Texture]

With respect to each of the multilayer coating films of Examples 1 to 15 and Comparative Examples 1 to 6, a degree of metallic texture (whether or not the multilayer coating film presented a texture of a nicely polished metal, or whether or not the multilayer coating film had strong flip-flop properties) was evaluated in three stages from the observation of the appearance. Table 1 shows the evaluation results. A double circle (□) indicates a high level of metallic texture, a circle (∘) an intermediate level of metallic texture, and a cross (x) a low level of metallic texture.

In Examples 1 to 15, multilayer coating films presenting metallic texture were obtained. The metallic texture level was high particularly in Examples 1, 2, and 14.

The metallic texture of Example 3 was evaluated as being a little inferior to the metallic texture of Examples 1 and 2. It is understood that this is because the lower coating film of Example 3 has inferior flip-flop properties due to the high L* value of its lower coating film. This is apparent also from the level of the evaluation, which is expressed by a cross (x), of the metallic texture of Comparative Example 6 (L* value=45).

The metallic texture of Example 4 was evaluated as being a little inferior to the metallic texture of Example 1. It is understood that this is because the aluminum flakes of Example 4 had a great surface roughness, and therefore because more light was reflected by the aluminum flakes as diffuse reflections, that is, geometric optical reflections were weak and metallic impressions were reduced. This is apparent also from the level of the evaluation, which is expressed by a cross (x), of the metallic texture of Comparative Example 2 (surface roughness Ra=45 nm).

The metallic texture of Example 5 was evaluated as being a little inferior to the metallic texture of Example 1. In Example 5, although the aluminum flake content was the same as that of Example 1, the number of aluminum flakes contained was greater than that of Example 1 because the thickness of each aluminum flake contained in Example 5 was thin. For this reason, the projected area occupancy (i.e., the rate of overlapping) of the aluminum flakes was great in Example 5. The effect of the diffuse reflection was therefore increased due to the level difference between the aluminum flakes, and it is understood that this is the reason why the metallic texture was evaluated as being a little inferior. On the other hand, the metallic texture of Example 6 was evaluated as being a little inferior to the metallic texture of Example 1. It is understood that this is because the thickness of each aluminum flake was thick in Example 6 as opposed to Example 5, and therefore because the projected area occupancy was reduced and the geometric optical reflection was weak.

The metallic texture of Example 7 was evaluated as being a little inferior to the metallic texture of Example 1. It is understood that this is because the particle size of the aluminum flake was small, and therefore because the effect of the diffuse reflection was increased due to the edges of the aluminum flakes. This is apparent also from the level of the evaluation, which is expressed by a cross (x), of the metallic texture of Comparative Example 3 (average particle size of aluminum flake=5 μm). On the other hand, the metallic texture of Example 8 was evaluated as being a little inferior to the metallic texture of Example 1. It is understood that this is because the particle size of the aluminum flake was great in Example 8 as opposed to Example 7, and therefore because particle texture was enhanced by such aluminum flakes. This is apparent also from the level of the evaluation, which is expressed by a cross (x), of the metallic texture of Comparative Example 4 (average particle size of aluminum flake=18 μm).

The metallic texture of Example 9 was evaluated as being a little inferior to the metallic texture of Example 1. It is understood that this is because the thickness of the upper coating film was thin, and therefore because the projected area occupancy was reduced and the geometric optical reflection was weak. On the other hand, the metallic texture of Example 10 was evaluated as being a little inferior to the metallic texture of Example 1. It is understood that this is because the thickness of the upper coating film was great, and therefore because the projected area occupancy (i.e., the rate of overlapping) was increased and the effect of the diffuse reflection was increased due to the level difference between the aluminum flakes.

The metallic texture of Example 11 was evaluated as being a little inferior to the metallic texture of Example 1. It is understood that this is because the aluminum flake content was small, and therefore because the projected area occupancy was reduced and the geometric optical reflection was weak. This is apparent also from the level of the evaluation, which is expressed by a cross (x), of the metallic texture of Comparative Example 5 (aluminum flake content=5%). On the other hand, the metallic texture of Example 12 was evaluated as being a little inferior to the metallic texture of Example 1. It is understood that this is because the aluminum flake content was great, and therefore because the projected area occupancy (i.e., the rate of overlapping) was increased and the effect of the diffuse reflection was increased by the level difference between the aluminum flakes. This is apparent also from the projected area occupancy, which exceeded 90%, of Comparative Example 1 (aluminum content=29%) and the level of the evaluation, which is expressed by a cross (x), of the metallic texture of Comparative Example 1.

The metallic texture of Example 13 was evaluated as being a little inferior to the metallic texture of Example 1. It is understood that this is because the particle size of the aluminum flakes was small, which somewhat increased the diffuse reflection due to the edges of the aluminum flakes, and also because the projected area occupancy (i.e., the rate of overlapping) of the aluminum flakes was great, which somewhat increased the diffuse reflection due to the level difference between the aluminum flakes. The metallic texture of Example 15 was evaluated as being a little inferior to the metallic texture of Example 14. It is understood that this is because the projected area occupancy (i.e., the rate of overlapping) of the aluminum flakes was great, which resulted in a somewhat stronger diffuse reflection due to the level difference between the aluminum flakes.

The upper coating film of each of the above Examples does not contain any coloring agent. However, a coloring agent, such as a pigment of a red color, for example, may be added to the upper coating film to obtain a metallic textured color.

### DESCRIPTION OF REFERENCE CHARACTERS

11 Automobile Body (Steel Plate)
12 Multilayer Coating Film
13 Electrodeposition Coating Film
14 Lower Coating Film
15 Upper Coating Film
16 Transparent Clear Coating Film
21 Pigment (Coloring Agent)
22 Aluminum Flake
23 Pigment (Coloring Agent)
25 Diffuse Reflection Due to Edge
26 Diffuse Reflection Due to Level Difference

1. A multilayer coating film comprising a lower coating film formed directly or indirectly on a surface of a coating target, and an upper coating film layered on the lower coating film, wherein
a lightness L* value of the lower coating film is 30 or less,
the upper coating film contains a large number of aluminum flakes as a luster material,
the aluminum flakes each have a surface roughness Ra of 30 nm or less,
the aluminum flakes each have a thickness of 70 nm or more and 150 nm or less,
the aluminum flakes contained in the upper coating film have an aspect ratio of 3 or less obtained by dividing a major axis length of the aluminum flake by a minor axis length thereof, and if a particle size of the aluminum flake is defined as a square root of a product of the major axis length and the minor axis length, an average particle size is 7 μm or more and 15 μm or less, and a standard deviation of a particle size distribution is 30% or less of the average particle size, and
when all the aluminum flakes contained in the upper coating film are projected on a surface of the upper coating film, a projected area occupancy, which is an area occupancy of projections of the aluminum flakes on the surface of the upper coating film, is 40% or more and 90% or less.

2. The multilayer coating film of claim 1, wherein
the projected area occupancy is 50% or more and 80% or less.

3. The multilayer coating film of claim 1, wherein
the upper coating film has a thickness of 1.5 μm or more and 4 μm or less.

4. A coated object comprising the multilayer coating film of claim 1.

5. The multilayer coating film of claim 2, wherein
the upper coating film has a thickness of 1.5 μm or more and 4 μm or less.

6. A coated object comprising the multilayer coating film of claim 2.

7. A coated object comprising the multilayer coating film of claim 3.

8. A coated object comprising the multilayer coating film of claim 5.
